(19) United States
(12) Patent Application Publication
(10) Pub. No.: US 2026/0265484 A1
(43) Pub. Date: Sep. 10, 2026

(54) POLYMER COMPOSITION

(71) Applicant: TRINAMIX GMBH, Ludwigshafen (DE)

(72) Inventor: Adrian VOGEL, Ludwigshafen (DE)

(21) Appl. No.: 19/166,580

(22) PCT Filed: Apr. 2, 2024
(86) PCT No.: PCT/EP24/58871

§ 371 Date: Sep. 18, 2025

(30) Foreign Application Priority Data
Apr. 4, 2023 (EP) 23166523.3

(51) Int. Cl. C08K 3/04; C08K 3/22; C08K 9/12

(52) U.S. Cl. CPC C08K 3/04; C08K 9/12; C08K 2003/2275

(57) ABSTRACT

Disclosed herein is a polymer composition containing
a polymer,
carbon particles and
a laser absorbing additive,
where at least a part of the surface of the polymer composition absorbs less infrared radiation than the bulk.

The invention is in the area of polymer compositions containing carbon particles suitable for infrared spectroscopy. The invention further relates to a method of producing a polymer composition, an article containing the polymer composition, the use of laser absorption additives to increase the infrared transparency a carbon particle-containing polymer composition at its surface and the use of the polymer composition or the article for plastic sorting based on infrared spectroscopy.

Polymers with a black color are often filled with carbon black pigments. For recycling, it is necessary to determine the type of polymer. This is typically achieved with infrared spectroscopy. However, carbon black strongly absorbs infrared radiation which hinders the determination of the type of polymer. Other black pigments with less infrared absorbance have been proposed.

JP 2006249411 A discloses a black pigment which is reflective in the infrared spectral range allowing sorting of plastics via infrared spectroscopy. However, carbon particles, in particular carbon black, has superior photostability, has an anti-static effect, and is easily available in high amount at low cost.

Hence, a polymer composition containing carbon particles was desired which can be detected by infrared radiation to allow sorting for recycling. This aim was achieved by the present invention.

In one aspect the present invention relates to a polymer composition containing
a polymer,
carbon particles and
a laser absorbing additive,
   wherein at least a part of the surface of the polymer composition absorbs less infrared radiation than the bulk.

In another aspect the present invention relates to an article containing the polymer composition according to the present invention.

In another aspect the present invention relates to a method for decreasing the infrared absorbance of a carbon particle-containing polymer composition at its surface comprising
a. providing a polymer composition containing a polymer, carbon particles and a laser absorbing additive and
b. exposing at least a part of the polymer composition to laser radiation.

In another aspect the present invention relates to the use of a laser absorbing additive to decrease the infrared absorbance of a carbon particle-containing polymer composition at its surface.

In another aspect the present invention relates to a polymer composition containing
a polymer,
carbon particles and
a laser absorbing additive,
   wherein at least a part of the surface of the polymer composition has been exposed to laser radiation.

In another aspect the present invention relates to the use of the polymer composition according to the present invention or an article according to the present invention for plastic sorting based on infrared spectroscopy.

The polymer composition contains a polymer. The polymer may be an organic polymer. The polymer may have a molecular weight of 10³ to 10⁷ g/mol, preferably 10⁴ to 10⁶ g/mol. Polymers include polyamide (PA), polyurethane (PU), low-density polyethylene (LDPE), high-density polyethylene (HDPE), polyethylene (PE), polypropylene (PP), polyvinyl chloride (PVC), polyvinyl acetate (PVA), polystyrene (PS), poly acrylonitrile butadiene styrene (ABS), poly styrene acrylonitrile (SAN), poly acrylate styrene acrylonitrile (ASA), polytetrafluoroethylene (Teflon), thermoplastic polyurethanes (TPU), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polybutylene terephthalate (PBT), polybutylene adipate coterephthalate (PBAT), polyester (PES), polyether sulfone (PESU), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO), polylactic acid (PLA), polysulfone (PSU), polyphenylene sulfone (PPSU); and copolymers and mixtures thereof.

Particularly preferred polymeric compositions may be selected from compositions comprising at least one polymer selected from PA 4, PA 5, PA 6, PA 7, PA 8, PA 9, PA 10, PA 11, PA 12, PA 46, PA 66, PA 666, PA 69, PA 610, PA 612, PA 96, PA 99, PA 910, PA 912, PA 1212, PA 6.T, PA 9.T, PA 8.T, PA 10.T, PA 12. T, PA 6.1, PA 8.1, PA 9.1, PA 10.1, PA 12.1, PA 6.T/6, PA 6.T/10, PA 6.T/12, PA 6.T/6.1, PA 6.T/8.T, PA 6.T/9.T, PA 6.T/ 10T, PA 6.T/12.T, PA 12.T/6.T, PA 6.T/ 6.1/6, PA 6.T/6.1/12, PA 6.T/6.1/6.10, PA 6.T/6.1/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.1, PA 8.T/8.6,PA 8.T/ 6.1, PA 10.T/6.T, PA 10.T/6.6, PA 10.T/10.1, PA 10T/10.1/6.T, PA 10.T/6.1, PA 4.T/4.1/46,PA 4.T/ 4.1/6.6, PA 5.T/ 5.1, PA 5.T/5.1/5.6, PA 5.T/5.1/6.6, PA 6.T/6.1/6.6, PA MXDA. 6, PA IPDA.I, PA IPDA.T, PA MACM.I, PA MACM.T, PA PACM.I, PA PACM.T, PA MXDA.I, PA MXDA.T, PA 6.T/IPDA.T, PA 6.T/MACM.T, PA 6.T/PACM.T, PA 6.T/MXDA.T, PA 6.T/6.1/8.T/8.1, PA 6.T/6.1/10.T/10.1, PA 6.T/6.1/IPDA.T/IPDA.I, PA 6.T/6.I/MXDA. T/MXDA.I, PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12. T/PACM.T, PA 10.T/IPDA.T, PA 12.T/IPDA.T; and copolymers and mixtures thereof; preferably PA 6 and PA 66; and copolymers and mixtures thereof.

The polymer composition contains carbon particles. Carbon particles preferably contain at least 90% carbon by weight, preferably at least 96% by weight, in particular at least 99% by weight. Carbon particles may have particle sizes of 10 to 500 nm, preferably 15 to 300 nm. The particle size may refer to the weight average particle size, for example determined by light scattering. The carbon particles may be individual particles or aggregates of particles or a mixture of both. The carbon particles may have various shapes, for example spherical, rod-like or sheet-like. The carbon particles may contain amorphous carbon, polycrystalline carbon, paracrystalline carbon like carbon black and/or crystalline carbon like graphite, carbon nanotube or graphene. The polymer composition preferably contains 0.01 to 10 % by weight carbon particles, more preferably 0.03 to 1% by weight, in particular 0.05 to 0.5% by weight, such as 0.1 to 0.2% by weight.

Preferably, the carbon particles contain carbon black. Carbon black may be produced by a number of different processes, for example a furnace black process, a channel black process, a gas black process, an acetylene black process or a Lampblack process. To increase the dispersibility of carbon black in a polymer, the carbon black may be surface-modified, for example by surface-oxidation or using surfactants.

The polymer composition contains laser absorbing additive. Laser absorption additives may be any compound or composition which is capable of absorbing laser light. Laser absorption additives may be any compound or composition which is capable of absorbing laser light other than carbon particles. Laser absorption additives are widely used in polymer compositions for labelling plastic parts by using a laser instead of a paint or for laser welding of plastic parts.

The laser absorption additive may be molecularly dispersed in the polymer or it may be in the form of particles dispersed in the polymer, preferably particles dispersed in the polymer. The laser absorption additive in the form of particles may have a particle size of 0.1 to 100 μm, preferably 0.5 to 60 μm, in particular 1 to 15 μm. The particle size may refer to the weight average particle size, for example determined by light scattering. The laser absorption additive may contain an organic dye, for example a rylene dye as disclosed in WO 2005/102 672 A1. Preferably, the laser absorption additive is in the form of particles dispersed in the polymer separate from the carbon particles. Hence, preferably, laser absorption additive particles and carbon particles are separately dispersed in the polymer, so laser absorption additive particles do not form a contact with the carbon particles.

The laser absorbing additive may contain a metal or semimetal, preferably a metal or semimetal salt such as an oxide, sulfide, selenide, nitride, phosphide, arsenide or antimonide. The laser absorption additive may contain a dopant, in particular a heavy metal, in particular a transition metal, for example niobium, or a rare earth metal. The laser absorbing additive may be organic or inorganic, preferably inorganic. The laser absorbing additive may contain 0.05 to 15% by weight dopant, preferably 0.1 to 10% by weight, in particular 0.3 to 5% by weight.

The laser absorption additive may contain two phases, for example a core-shell structure. The core may contain silicate materials such as natural or synthetic mica, talc or sericite, undoped or doped titanium dioxide, alumina, silica, carbon, graphite, iron oxide, barium sulfate or pearl pigments. The shell may contain a laser-absorbing compound, for example (Sn, Sb)-oxide, Sb₂O₃ or Fe₃O₄. The weight ratio shell to core of the pigment is in the range of 50:50 to 95:5, relative to the weight of the entire core-shell particle. Examples for laser absorption additives containing two phases are (Sn, Sb)-oxide on mica or TiO₂, Sb₂O₃ on polyethylene or Fe₃O₄ on mica. Some laser absorbing additives are commercially available under the trademark Iriotec® from Merck KGaA. Examples for synthesizing the core-shell particles are disclosed in WO 2017/016 645 A1 or in WO 2018/095 834 A1 .

The polymer composition preferably contains 0.001 to 20% by weight, preferably 0.01 to 10% by weight, in particular 0.05 to 3% by weight laser absorbing additive.

The polymer composition may contain other ingredients such fillers and other additives such as flame retardants, antioxidants, light stabilizers, process aids, or inorganic fillers.

Preferably, the polymer composition contains
80 to 99.98% by weight polymer,
0.01 to 10% by weight carbon particles and
0.01 to 10% by weight laser absorbing additive.

The polymer, the carbon particles and laser absorption additive may be combined in various ways, for example by compounding, via a masterbatch, via pastes or by direct addition during the shaping processing step (direct pigmentation). The resulting mixture may be shaped into an article by molding, extrusion or sintering. An article may contain, essentially consist of or consist of the polymer composition. Examples for articles are consumables like bottles, cups, syringes, bags; or structural parts like furniture such as chairs, vehicle parts like bumpers, appliances like hair dryer cases or keyboards, building materials like water barrier foils or insulating foams, agricultural or gardening parts like plant pots, toys like plastic dolls.

The surface of the polymer composition may refer to an outer layer of the polymer composition, typically facing the surrounding air. The remaining of the polymer composition may be referred to as the bulk, so typically the major part of the polymer composition which is covered by the surface. The surface may have a thickness of 1 μm to 5 mm, preferably 10 μm to 1 mm, for example 20 μm to 100 μm. For example, the surface of the polymer may be an outer layer of the polymer composition with a thickness of 20 μm and the bulk of the polymer composition may be the remaining of the polymer composition.

At least a part of the surface of the polymer composition is less absorptive to infrared radiation. This means that the entire surface of the polymer composition or only a part of the surface of the polymer composition is less absorptive to infrared radiation. The part may be dimensioned such that infrared spectroscopy can be performed at that part. This may be achieved by a small area, for example a 1×1 cm area. The article containing the polymer composition may contain a label indicating the part of the surface of the polymer composition with decreased absorbance of infrared radiation. The part of the surface of the polymer composition with decreased absorbance may be part of the label or may be close to the label. The label may contain product information about the article, in particular information related to the recycling of the polymer composition, for example the polymer, additive, the producer of the article or the date of production.

Infrared radiation may have a wavelength of 760 nm to 1000 μm. Infrared radiation includes near infrared radiation with a wavelength of 760 nm to 3 μm, mid infrared radiation with a wavelength of 3 μm to 15 μm and far infrared radiation with a wavelength of 15 μm to 1000 μm. Preferably, infrared radiation refers to near infrared radiation, in particular with a wavelength of 1.5 to 2.5 μm.

Absorbing less infrared radiation may mean that the absorbance at least one wavelength in the infrared region is lower at the surface compared to the bulk of the polymer composition. Hence, infrared radiation may be transmitted, diffracted, or reflected with a decreased extent of absorption. Preferably, the absorbance of infrared radiation of at least part of the surface is less than 50% of the absorbance of infrared radiation of the bulk, more preferably less than 30%, in particular less than 20%. The absorbance of infrared radiation at the surface is preferably low enough so absorption bands of the polymer usable to detect the polymer by infrared spectroscopy. As carbon particles have a high absorbance of infrared irradiation, their absorption may be decreased.

The decrease in absorption of infrared radiation may be achieved by exposing the composition containing a polymer, carbon particles and a laser absorbing additive to laser radiation. It has surprisingly been found out that decreasing the absorption of infrared radiation by using laser radiation is only achieved in the presence of the laser absorbing additive. The effect has not been observed with polymers only containing carbon particles which tend to burn and form bubbles at the surface, while this is not the case in the presence of a laser absorption additive.

Laser radiation of various wavelength can be used, for example in the range from 100 nm to 32 μm, preferably in the range from 355 nm to 10.9 μm and most preferably in the range from 800 nm to 1200 nm. Examples for suitable lasers are CO₂ lasers (about 10.6 μm), Nd:YAG lasers (about 1064 nm), YVQ4 lasers (about 1064 nm), fiber lasers (about 1062 nm), green lasers (532 nm), UV lasers (355 nm), semiconductor diode lasers (405-3330 nm), excimer lasers such as F2 excimer laser (157 nm), ArF excimer laser (193 nm), KrCl excimer laser (222 nm), KrF excimer laser (248 nm), XeCl excimer laser (308 nm) and XeF excimer laser (351 nm).

The polymer composition may be exposed to laser radiation for various amounts of time depending on the desired thickness of the surface layer with decreased absorbance of infrared radiation and the desired degree of decrease of absorbance of infrared radiation. Preferably, the polymer composition is exposed to laser radiation for 1 μs to 10 ms, more preferably 5 μs to 1 ms, in particular 10 to 100 μs. The power of the laser may also depend on the desired thickness of the surface layer with decreased absorbance of infrared radiation and the desired degree of decrease of absorbance of infrared radiation. Preferably, the laser power per surface area is 1 to 500 kW/mm² , more preferably 3 to 100 kW/mm² , in particular 5 to 30 kW/mm². The laser radiation may be pulsed, for example with a pulse frequency of 10 Hz to 1 MHz, preferably 1 kHz to 500 kHz, in particular 10 kHz to 200 kHz.

Consequently, a laser absorbing additive can be used to decrease the infrared absorbance of a carbon particle-containing polymer composition at its surface. The laser absorbing additive may be used to enable infrared spectroscopy on a carbon particle-containing polymer composition. The laser absorbing additive may be used for enabling plastic sorting based on infrared spectroscopy. The laser absorbing additive may be used for enabling the recycling of a polymer composition. An article containing the polymer composition of the present invention may be subject to infrared spectroscopy at the surface with decreased infrared absorbance. In this way, the chemical nature of the polymer or the type of polymer, for example PA verses PP, in the polymer composition can be detected. This allows sorting of different articles containing polymers according to the type of polymer in the polymer composition. Without such sorting, a mixture of polymers is obtained with inferior quality, so no meaningful recycling is possible.

### EXAMPLE

Polyamide 6 containing 0.4% Fe₃O₄ on mica (<15 μm) and 0.1% carbon black powder (P.BK.7) was molded into a plate. The plate was hit by a 1064 nm fiber laser with a power of 10 Wand a beam diameter of 0.025 mm at a pulsing frequency of 50-100 kHz, wherein the laser was moved over the plate at a speed of 2000 mm/s.

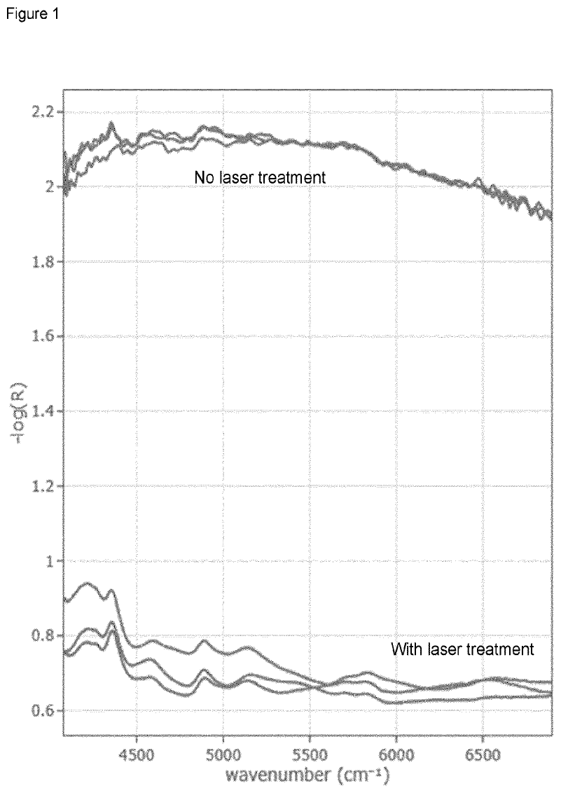

The plate was subjected to infrared spectroscopy. FIG. 1 shows the absorption spectra, wherein the lower three curves correspond to measurements on the sample treated by the laser and the upper curves correspond to measurements on the sample not treated by the laser. It becomes apparent that the IR absorption in the measured range decreases significantly such that the absorption spectrum of the PA polymer becomes visible. In the case of the untreated samples the polymer absorption spectra are completely superimposed by the absorption of the carbon particles making it impossible to detect the polymer.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality. A single unit or device may fulfill the functions of several items recited in the claims. The mere fact that certain measures are recited in mutually different dependent claims does not indicate that a combination of these measures cannot be used to advantage.

1. A polymer composition comprising
a polymer,
carbon particles, and
a laser absorbing additive,
wherein at least a part of a surface of the polymer composition absorbs less infrared radiation than a bulk.

2. The polymer composition according to claim 1, wherein an absorbance of infrared radiation of the at least part of the surface is less than 50% of an absorbance of infrared radiation of the bulk.

3. The polymer composition according to claim 1, wherein the at least part of the surface of the polymer composition absorbs less infrared radiation with a wavelength of 1.5 to 2.5 pm.

4. The polymer composition according to claim 1, wherein the laser absorbing additive is in a form of particles and comprises a metal or semimetal salt.

5. The polymer composition according to claim 1, wherein the laser absorbing additive comprises Fe₃O₄ on mica.

6. The polymer composition according to claim 1, wherein the polymer composition comprises
80 to 99.98% by weight polymer,
0.01 to 10% by weight carbon particles, and
0.01 to 10% by weight laser absorbing additive.

7. An article comprising the polymer composition according to claim 1.

8. The article according to claim 7, wherein the article is a part of a vehicle.

9. The article according to claim 7, wherein the article comprises a label indicating the part of the surface of the polymer composition with decreased absorbance of infrared radiation.

10. A method for decreasing the infrared absorbance of a carbon particle comprising polymer composition at its surface comprising
a. providing a polymer composition comprising a polymer, carbon particles and a laser absorbing additive; and
b. exposing at least a part of the polymer composition to laser radiation.

11. The method according to claim 10, wherein the laser radiation has a wavelength of 800 nm to 1200 nm.

12. The method according to claim 10, wherein the laser radiation has a power per surface area of 3 to 100kW/mm².

13. A method of using a laser absorbing additive, the method comprising using the absorbing additive to decrease the infrared absorbance of a carbon particle comprising polymer composition at a surface of the carbon particle-comprising polymer composition.

14. The method according to claim 13, wherein the method comprises using the absorbing additive to enable infrared spectroscopy on a carbon particle-containing polymer composition for recycling.

15. A method of using the polymer composition according to claim 1, the method comprising using the polymer composition for plastic sorting based on infrared spectroscopy.

16. A method of using the article according to claim 7, the method comprising using the article for plastic sorting based on infrared spectroscopy.
